(19) United States
(12) Patent Application Publication
(10) Pub. No.: US 2007/0088471 A1
(43) Pub. Date: Apr. 19, 2007

(54) System for transmitting vehicle state information

(76) Inventors: Sang-Woo Park, Hwaseong-si (KR); Won-Keun Lee, Hwaseong-si (KR); Deug-Yong Cha, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/299,379

(22) Filed: Dec. 8, 2005

(30) Foreign Application Priority Data
Oct. 13, 2005 (KR) 10-2005-0096419

(51) Int. Cl. G06F 19/00

(52) U.S. Cl. 701/33; 701/29; 340/438

(57) ABSTRACT

Disclosed herein is a system for transmitting vehicle state information. The system includes a Smartcard Control Unit (SCU) configured to store the vehicle state information, and to have a Universal Serial Bus (USB) port; a personal terminal for receiving and reading the vehicle state information from the SCU through a smartcard; a web server for storing the vehicle state information; and a repair shop terminal having a USB port configured to be connected to the USB port installed in the SCU through a USB cable and to receive the vehicle state information.

### CROSS-REFERENCE TO RELATED APPLICATIONS

The present application is based on, and claims priority from, Korean Application Serial Number 10-2005-0096419, filed on Oct. 13, 2005, the disclosure of which is hereby incorporated by reference herein in its entirety.

### FIELD OF THE INVENTION

The present invention relates generally to a system for transmitting vehicle state information and, more particularly, to a system for transmitting vehicle state information, such as vehicle diagnostic information, navigation information, or the time for the replacement of consumables, from a Smartcard Control Unit (SCU) to a repair shop terminal.

### BACKGROUND OF THE INVENTION

Conventionally, in order for a personal terminal and a repair shop terminal to receive vehicle state information such as vehicle diagnostic information, navigation information, or the time for the replacement of consumables from an SCU, which receives data from the electronic control devices and sensors of a general vehicle and stores the vehicle state information, each of the personal and repair shop terminals is equipped with a smartcard and a smartcard reader for reading data stored in the smartcard and performs the transmission and reading of the data.

That is, since both a repair shop and a personal terminal separately include the smartcard and the smartcard reader in order to receive current vehicle state information, a problem occurs in that costs are incurred.

### SUMMARY OF THE INVENTION

Embodiments of the present invention provide a system for transmitting vehicle state information, which can replace the smartcard and smartcard reader of a repair shop that are required to receive vehicle state information from an SCU in which the vehicle state information is stored.

A system for transmitting vehicle state information according to an embodiment of the present invention includes a Smartcard Control Unit (SCU) configured to store the vehicle state information and to have a Universal Serial Bus (USB) port. A personal terminal receives and reads the vehicle state information from the SCU through a smartcard. A web server stores the vehicle state information. A repair shop terminal includes a USB port configured to be connected to the USB port installed in the SCU through a USB cable and to receive the vehicle state information.

### BRIEF DESCRIPTION OF THE DRAWINGS

For a better understanding of the nature and objects of the present invention, reference should be made to the following detailed description with the accompanying drawings, in which:

FIG. 1 is a diagram showing the construction of a system according to a first embodiment of the present invention;

FIG. 2 is a diagram showing the construction of a system according to a second embodiment of the present invention; and

FIG. 3 is a diagram showing the construction of a system according to a third embodiment of the present invention.

### DETAILED DESCRIPTION OF THE PREFERRED EMBODIMENTS

Preferred embodiments of the present invention are described with reference to the accompanying drawings.

### First Embodiment

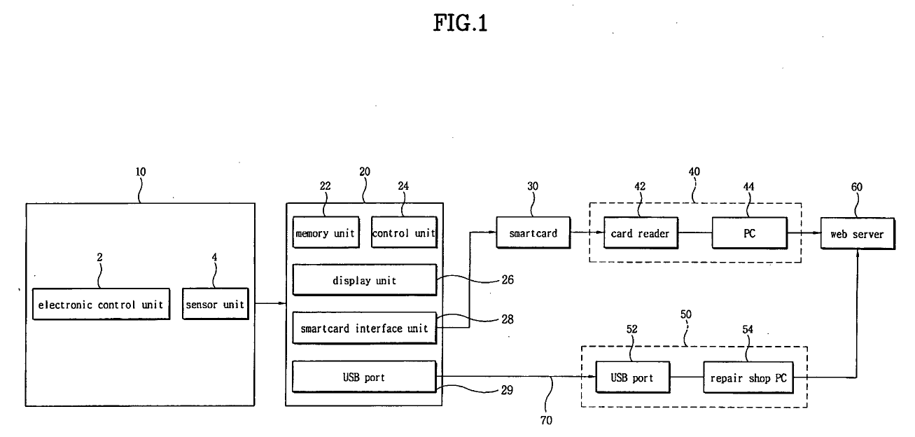

The construction of a system for transmitting vehicle state information according to a first embodiment of the present invention is described with reference to FIG. 1.

As illustrated in FIG. 1, according to the embodiment, the system for transmitting vehicle state information includes an SCU 20 configured to store the vehicle state information and to have a Universal Serial Bus (USB) port 29, a personal terminal 40 for receiving and reading the vehicle state information from the SCU 20 through a smartcard 30, a web server 60 for storing the vehicle state information, and a repair shop terminal 50 having a USB port 52 configured to be connected to the USB port 29 installed in the SCU 20 through a USB cable 70 and to receive the vehicle state information.

The vehicle state information according to the present invention includes vehicle diagnostic information, navigation information, and consumables replacement information.

Furthermore, the SCU20 includes a memory unit 22, a control unit 24, a display unit 26, a smartcard interface unit 28 (a slot for the insertion of the smartcard), and the USB port 29. The SCU 20 receives various data from the electronic control unit 2 of a vehicle 10, that is, an ECU, a TCS, a TCU, an ECS, an ABS, an ACU and a sensor unit 4, and stores it in the memory unit 22.

The personal terminal 40 includes a card reader 42 for reading a smartcard, and a Personal Computer(PC) or portable communication means 44.

The repair shop terminal 50 includes a PC 54 having a USB port 52. The repair shop PC 54 of the repair shop terminal 50 transmits vehicle diagnostic information, navigation information, and consumable replacement information to the web server 60.

Using the above-described construction of the system, the repair shop terminal 50 according to the present embodiment receives the vehicle state information stored in the SCU 20 through the USB port connected to the USB cable 70 without using a smartcard or a card reader, and the information is utilize at the time of repair of the vehicle.

### Second Embodiment

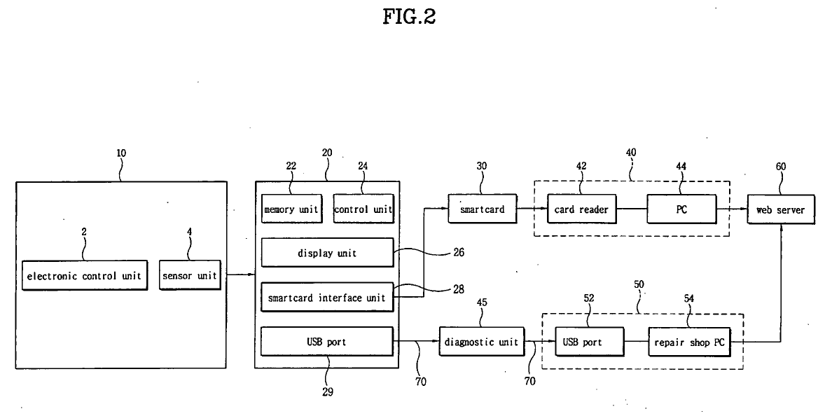

The construction of a system for transmitting vehicle state information according to a second embodiment of the present invention is described with reference to FIG. 2.

As illustrated in FIG. 2, according to the present embodiment, the system for transmitting vehicle state information includes an SCU 20 configured to store the vehicle state information and to have a USB port 29, a personal terminal 40 for receiving and reading the vehicle state information from the SCU 20 through a smartcard 30, a web server 60 for storing the vehicle state information, a vehicle diagnostic unit 45 having a USB port (not shown) connected to the USB port 29 installed in the SCU 20 through a USB cable 70 and configured to receive the vehicle state information, and a repair shop terminal 50 having a USB port 52 configured to be connected to the USB port installed in the vehicle diagnostic unit 45 through a USB cable 70 and to receive the vehicle state information.

The vehicle state information according to the present embodiment includes vehicle diagnostic information, navigation information, and consumables replacement information.

Furthermore, the SCU 20 includes a memory unit 22, a control unit 24, a display unit 26, a smartcard interface unit 28 (a slot for the insertion of the smartcard), and the USB port 29. The SCU 20 receives various data from the electronic control unit 2 of a vehicle 10, that is, an ECU, a TCS, a TCU, an ECS, an ABS, an ACU and a sensor unit 4, and stores it in the memory unit 22.

The vehicle diagnostic unit 45 is a scanner for a diagnosis of a vehicle breakdown.

The personal terminal 40 includes a card reader 42 for reading the smartcard, and a PC or portable communication means 44.

The repair shop terminal 50 includes a PC 54 having the USB port 52, and receives the vehicle state information from the vehicle diagnostic unit 45 connected to the USB cable 70. The repair shop PC 54 of the repair shop terminal 50 transmits vehicle diagnostic information, navigation information, and consumable replacement information to the web server 60.

Using the above-described construction of the system, the repair shop terminal 50 according to the present embodiment receives the vehicle state information stored in the vehicle diagnostic unit 45 through the USB port connected to the USB cable 70 without using a smartcard or a card reader, and the information is utilized at the time of repair of the vehicle.

### Third Embodiment

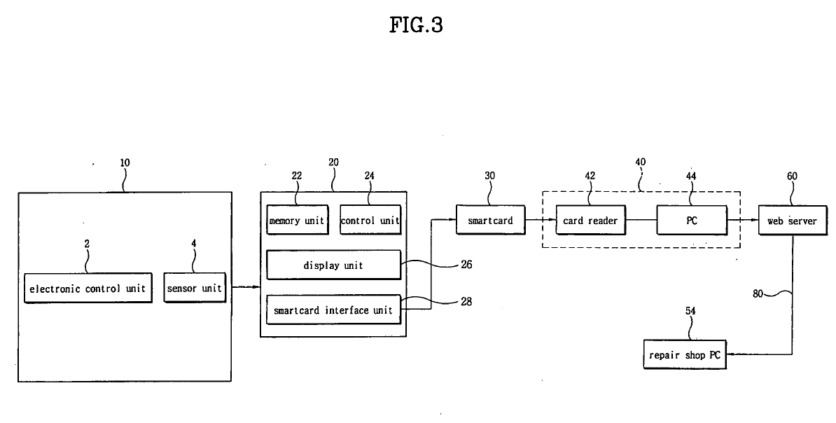

The construction of a system for transmitting vehicle state information according to a third embodiment of the present invention is described with reference to FIG. 3.

As illustrated in FIG. 3, according to the embodiment, the system for transmitting vehicle state information includes an SCU 20 configured to store the vehicle state information, a personal terminal 40 for receiving and reading the vehicle state information from the SCU 20 through a smartcard 30, a web server 60 for storing the vehicle state information, and a PC 54 for receiving the vehicle state information from the web server 60 through a communication line.

As described in conjunction with the first and second embodiments, the vehicle state information according to the present invention includes vehicle diagnostic information, navigation information, and consumables replacement information.

Furthermore, the SCU 20 includes a memory unit 22, a control unit 24, a display unit 26 and a smartcard interface unit 28 (a slot for the insertion of the smartcard). The SCU 20 receives various data from the electronic control unit 2 of a vehicle 10, that is, an ECU, a TCS, a TCU, an ECS, an ABS, an ACU and a sensor unit 4, and stores it in the memory unit 22.

The data transmission from the web server 60 to the repair shop PC 54 is performed using a wired or wireless communication means. The data transmission using the wired or wireless communication means can be performed using various methods by those skilled in the art.

The personal terminal 40 includes a card reader 42 for reading the smartcard, and a PC or portable communication means 44.

Using the above-described construction of the system, the repair shop terminal, that is, the repair shop PC 54, according to the present embodiment receives data (for example, vehicle state information) from the web server 60 the stores the vehicle state information without using a smartcard or a card reader, and the information is utilized at the time of repair of the vehicle.

In the present invention, as described in conjunction with the first, second and third embodiments, a repair shop can receives vehicle state information through the USB port connected to the USB cable, through the connection of the USB cable to the vehicle diagnostic unit, or through a communication line from the web server storing the vehicle state information without using the smartcard or the card reader for reading the smartcard, and the current vehicle information is utilized at the time of repair of the vehicle.

According to a system for transmitting vehicle state information of the present invention, a repair shop does not require a separate smartcard and a separate reader for reading the smartcard, so that the present invention is advantageous in that the convenience and cost reduction of the data transmission are achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for transmitting vehicle state information, comprising:
a Smartcard Control Unit (SCU) configured to store the vehicle state information, and to have a Universal Serial Bus (USB) port;
a personal terminal for receiving and reading the vehicle state information from the SCU through a smartcard;
a web server for storing the vehicle state information; and
a repair shop terminal having a USB port configured to be connected to the USB port installed in the SCU through a USB cable and to receive the vehicle state information.

2. The system as defined in claim 1, wherein the vehicle state information comprises vehicle diagnostic information, navigation information, and consumables replacement information.

3. A system for transmitting vehicle state information, comprising:
an SCU configured to store the vehicle state information, and to have a USB port;
a personal terminal for receiving and reading the vehicle state information from the SCU through a smartcard;
a web server for storing the vehicle state information;
a vehicle diagnostic unit having a USB port configured to be connected to the USB port installed in the SCU through the USB cable and to receive the vehicle state information; and
a repair shop terminal having a USB port configured to be connected to the USB port installed in the vehicle diagnostic unit through a USB cable and to receive the vehicle state information.

4. The system as defined in claim 3, wherein the vehicle diagnostic unit is a scanner for a diagnosis of a vehicle breakdown.

5. The system as defined in claim 3, wherein the vehicle state information comprises vehicle diagnostic information, navigation information, and consumables replacement information.

6. A system for transmitting vehicle state information, comprising:
an SCU configured to store the vehicle state information;
a personal terminal for receiving and reading the vehicle state information from the SCU through a smartcard;
a web server for storing the vehicle state information; and
a Personal Computer (PC) for receiving the vehicle state information from the web server through a communication line.

7. The system as defined in claim 6, wherein the data transmission from the web server to the repair shop PC is performed using a wired or wireless communication manner.

8. The system as defined in claim 6, wherein the vehicle state information comprises vehicle diagnostic information, navigation information, and consumables replacement information.
